(19) United States
(12) Patent Application Publication
(10) Pub. No.: US 2007/0111588 A1
(43) Pub. Date: May 17, 2007

(54) Support Means with Connection Able to Accept Shearing Force for Connecting Several Cables

(75) Inventor: Karl Weinberger, Immensee (CH)

Correspondence Address: BUTZEL LONG, STONERIDGE WEST, 41000 WOODWARD AVENUE, BLOOMFIELD HILLS, MI, 48304, US

(73) Assignee: INVENTIO AG, Hergiswil NW (CH)

(21) Appl. No.: 11/421,231

(22) Filed: May 31, 2006

(30) Foreign Application Priority Data
Jun. 2, 2005 (EP) 05104788.4

(51) Int. Cl. H01R 4/24

(52) U.S. Cl. 439/417

(57) ABSTRACT

A support for an elevator installation includes at least two cables of several strands each, which cables are designed for acceptance of force in a longitudinal direction, and wherein the cables are arranged along the longitudinal direction of the support at a spacing from one another and are connected by a cable casing. The cable casing has a transition region which lies between the cables and is provided with openings and webs. The webs are formed to enable a relative displacement of the cables relative to one another in the longitudinal direction.

### BACKGROUND OF THE INVENTION

The present invention relates to a support means for use in an elevator installation with several cables extending at a spacing from one another and a cable casing.

Running cables are an important, highly loaded machine element in conveying technology, particularly in the case of elevators, in crane construction and in mining. The loading of driven cables, as used in, for example, elevator construction, is particularly complex.

In the case of conventional elevator installations, elevator car and counterweight are connected together by way of several steel strand cables. The cables run over a drive pulley driven by a drive motor. The drive moment is imposed under friction couple on the respective cable section lying on the drive pulley over the looping angle. In that case the cable experiences tension, bending, compression and torsional stresses. The relative motions arising due to the bending over the cable pulley cause friction within the cable structure, which can have a negative effect on cable wear. Depending on a respective cable construction, bending radius, groove profile and cable safety factor the primary and secondary stresses which arise have a negative influence on the cable state.

Apart from strength requirements, there is the further requirement in the case of elevator installations for, for reasons of energy, smallest possible masses. High-strength synthetic fiber cables, for example of aromatic polyamides, especially aramides, fulfill these requirements better than steel cables.

Cables made of aramide fibers have, for the same cross-section and same load-bearing capability, by comparison with conventional steel cables only a quarter to a fifth of the specific cable weight. By contrast to steel, however, aramide fiber has a substantially lower transverse strength in relation to longitudinal load-bearing capability.

Consequently, in order to expose the aramide fibers to the smallest possible transverse stresses when running over the drive pulley a parallelly stranded aramide fiber strand cable suitable as a drive cable is proposed in, for example, European Patent Application EP 0 672 781 A1. The aramide cable known therefrom offers very satisfactory values with respect to service life, high abrasion strength and alternate bending strength; however, in unfavorable circumstances the possibility exists with parallelly stranded aramide cables that partial cable unraveling phenomena occur which permanently disturb the original cable structure in its balance. These twisting phenomena and the changes in cable structure can be avoided with, for example, a synthetic fiber cable according to European Patent Application EP 1 061 172 A2. For this purpose the synthetic fiber cable comprises two parallelly extending cables which are connected together by way of a cable casing. The synthetic fiber cable according to EP 1 061 172 A2 achieves a longitudinal strength substantially through the characteristics of the two cables extending in parallel. The cable casing, thereagainst, prevents twisting phenomena and changes in the cable structure. Moreover, the cable casing serves as insulation (protective effect) and it has a high coefficient of friction. A weak point can be, depending on the respective field of application and use, the web of such a synthetic fiber cable according to EP 1 061 172 A2.

Support means with two and more cables have disadvantages if they are so moved during running around a drive pulley that the individual cables run on tracks with different radius. Due to the radius differences the cables are moved by the traction of the drive pulley at different speed. The web part of the cable casing is thereby exposed to a shearing stress. Due to the shearing action the web region of the cable casing can be damaged, particularly when shearing forces occurring dynamically are concerned.

### SUMMARY OF THE INVENTION

The present invention has an object of further improving the known support means, which comprise two or more cables, in order inter alia to avoid web fracture. This applies particularly to support means comprising synthetic fiber cables.

The invention is based on recognition that the stated problems do not gain the upper hand if the web region is stiffened. Thus, the direct effects of shearing forces can indeed be prevented, but in this case the more rapidly circulating cable drags along the other cable and slip occurs which causes increased abrasion.

### DESCRIPTION OF THE DRAWINGS

The above, as well as other, advantages of the present invention will become readily apparent to those skilled in the art from the following detailed description of a preferred embodiment when considered in the light of the accompanying drawings in which:

FIG. 1A is a perspective illustration of a first support means according to the present invention with two cables;

FIG. 1B is a plan view of the support means according to FIG. 1A;

FIG. 2 is a plan view of a second embodiment support means according to the present invention with two cables and rectangular webs;

FIG. 3 is a plan view of a third embodiment support means according to the present invention with two cables and parallelogram-shaped webs with obliquely extending edges; and

FIG. 4 is a plan view of a fourth embodiment support means according to the present invention with two cables and convexly shaped webs.

### DESCRIPTION OF THE PREFERRED EMBODIMENT

Constructional elements which are the same or have the same effect are provided in all figures with the same reference numerals even if they are not of identical construction in details. The figures are not to scale.

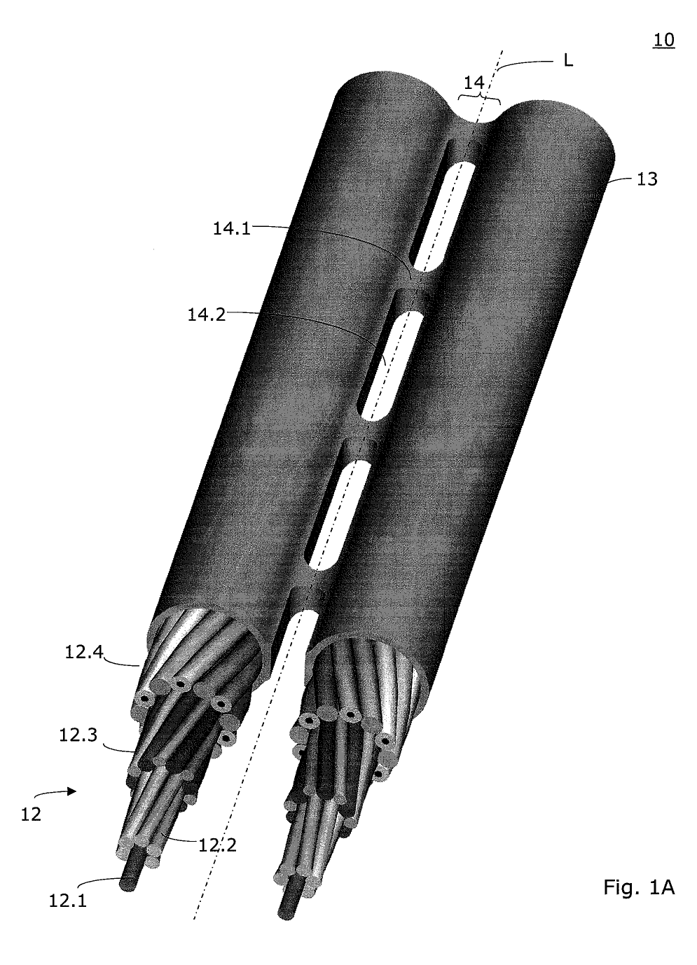

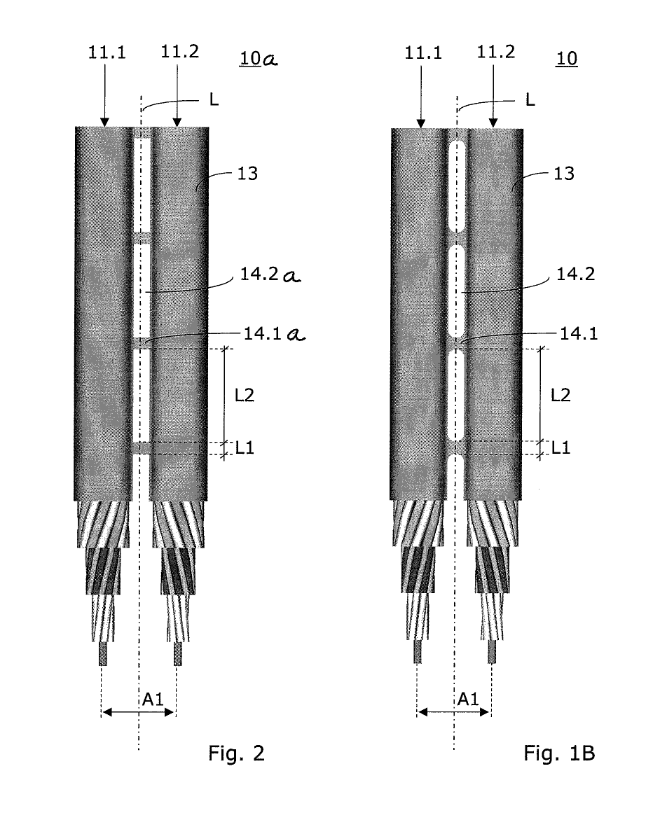

A first support means 10 for use in an elevator installation is shown in FIG. 1A and FIG. 1B. The support means 10 comprises at least two cables 11.1 and 11.2. These cables 11.1 and 11.2 comprise, for example, a plurality of synthetic fiber strands 12 designed for acceptance of force in a longitudinal direction L. The cables 11.1 and 11.2 are arranged parallel to one another along the longitudinal direction L of the support means 10 at a spacing Al (center-to-center). The cables 11.1, 11.2 are fixed relative to one another, to be secure against twisting, by a cable casing 13. The cable casing 13 forms a transition region 14, which extends parallel to the longitudinal direction L of the support means 10, between the two cables, 11.1, 11.2.

According to the present invention the transition region 14 of the cable casing 13, which lies between the cables 11.1, 11.2, is provided with openings 14.2 and webs 14.1. The webs 14.1 are formed so that they make possible a relative movement of the cables 11.1, 11.2 with respect to one another in the longitudinal direction L.

It can be seen on the basis of FIGS. 1A and 1B how this transition region 14 is designed in the case of the first embodiment. The cable casing 13 is a common cable casing which encloses the first cable 11.1 and the second cable 11.2. The cable casing 13 extends over into the transition region 14 to the webs 14.1, which webs ultimately serve as the sole connections between the two adjacent cables 11.1 and 11.2.

According to the present invention at least two cables are thus connected together, but not by a rigid connection. The connection between the adjacent cables 11.1, 11.2 of the support means 10 according to the present invention is created by way of the webs 14.1, which webs on the one hand make possible transmission of torsional moments from one cable 11.1 to the adjacent cable 11.2, but on the other hand enable displacement of the cables 11.1, 11.2 relative to one another in the longitudinal direction L of the support means 10.

It is important that the webs 14.1 are so designed that they make possible the relative displacement at least in certain sections of the support means 10 without, however, breaking or tearing.

The first embodiment, which is shown in FIGS. 1A and 1B, of the support means 10 has openings 14.2 which are straight on the two longitudinal sides (parallel to the longitudinal axis L) and outwardly convex in the end regions. The webs 14.1 in the plan view shown in FIG. 1B are correspondingly dumbbell-shaped. The webs 14.1 thus have, as seen in longitudinal direction, boundaries which extend into the web concavely.

The term “relative displacement of the adjacent cables” includes, according to the present invention, two cases:

(1) the two cables 11.1, 11.2 can be uniformly displaced relative to one another over their entire length (with the same stretching of the cables); and

(2) one of the cables 11.1 and 11.2 can be stretched more than the other, wherein, during the stretching, relative displacements between individual length sections of the respective cables arise (the amount of the relative displacement in that case depends on the length position on the cable).

Further embodiments of the support means according to the present invention each with the two cables 11.1, 11.2 are shown in FIGS. 2, 3 and 4. These support means are, as also the support means 10 shown in FIGS. 1A, 1B, designed for use in an elevator installation. The support means comprise the two cables 11.1, 11.2, wherein each of the cables includes several of the strands 12. The cables 11.1, 11.2 are designed for acceptance of force in the longitudinal direction L, wherein the cables 11.1, 11.2 are arranged along the longitudinal direction L of the support means at the spacing A1 from one another and are connected by means of the common cable casing 13. The cable casing 13 forms the transition region 14 between the two cables 11.1, 11.2. The transition region of the cable casing 13, which lies between the cables 11.1, 11.2, is provided with openings and webs (similar to the openings 14.2 and the webs 14.1), wherein also in the case of the embodiments shown in FIGS. 2, 3 and 4 the webs are designed so that they enable a relative movement of the cable 11.1, 11.2 with respect to one another in the longitudinal direction L.

The embodiments shown in FIGS. 2, 3 and 4 differ substantially only by the form of the webs and by the dimensioning of the webs or the openings.

The second embodiment of the support means, which is shown in FIG. 2, is a support means 10a having a plurality of openings 14.2a which are straight on two longitudinal sides (parallel to the longitudinal axis L) and which are straight in end regions, i.e. the openings 14.2 are substantially rectangular in the plan view shown in FIG. 2. Correspondingly, a plurality of webs 14.1a in the plan view shown in FIG. 2 are rectangular or square.

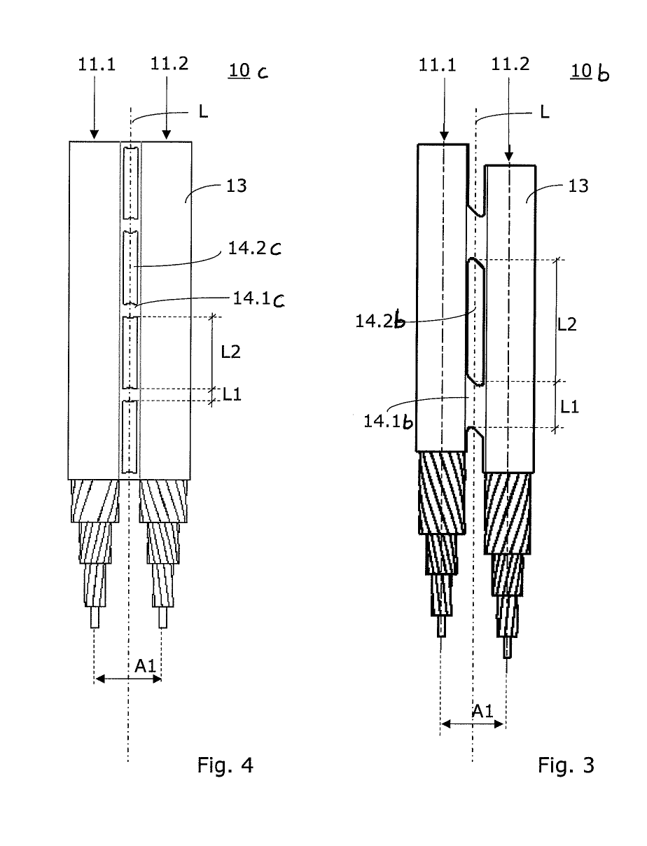

The third embodiment of the support means, which is shown in FIG. 3, is a support means 10b having a plurality of openings 14.2b which extend rectilinearly on two longitudinal sides (parallel to the longitudinal axis L) and which extend at an inclination in end regions, i.e. the openings 14.2b are approximately parallelogram-shaped in the plan view shown in FIG. 3. Correspondingly, a plurality of webs 14.1b in the plan view shown in FIG. 3 are also lozenge-shaped with obliquely extending edges.

The fourth embodiment of the support means, which is shown in FIG. 4, is a support means 10c having openings 14.2c which are straight on two longitudinal sides (parallel to the longitudinal axis L) and which are concave in end regions. Correspondingly, a plurality of webs 14.1c in the plan view shown in FIG. 4 are curved outwardly at both sides, i.e. convex.

The described principle can also be transferred to an assembly of three and more cables.

In the preferred embodiments of the present invention the strands 12 of the cables are laid so that at least two of the cables of the support means 10, 10a, 10b, 10cbuild up, under torsional stress, (mutually compensating) intrinsic torsional moments of opposite sense.

In the examples shown in the figures the strands 12 of each of these cables are respectively laid parallelly (with the same rotational sense), whilst the strands of adjacent cables 11.1 and 11.2 are laid with opposite rotational sense.

The webs 14.1, 14.1a, 14.1b, 14.1c are an integral component of the casing 13. They can in this case be made in a single production step (by extrusion or vulcanization according to the respective material) together with the casing 13.

The webs 14.1, 14.1a, 14.1b, 14.1c can be either produced during production of the casing 13 together therewith or they can be formed in a subsequent step (for example, by punching).

An optimization parameter is the elasticity of the webs 14.1, 14.1a, 14.1b, 14.1c. Through optimization of the elasticity, relative displacements of the cables are allowed and disturbing shear stresses in the transition region 14 between adjacent cables 11.1, 11.2 can be reduced.

Advantageously the length ratios between the webs 14.1, 14.1a, 14.1b, 14.1c and the openings 14.2, 14.2a, 14.2b, 14.2c are so selected that the webs of resilient material function to a first approximation in an articulated manner under shearing forces in the longitudinal direction (L) of the cables, i.e. the webs can accept substantially only forces in a transverse direction with respect to the cables 11.1 and 11.2. Such webs 14.1, 14.1a, 14.1b, 14.1c constructed in an articulated manner thus cannot accept substantial forces in the longitudinal direction (L) when there are small relative displacements of the cables 11.1 and 11.2 and thus avoid, in the case of occurrence of different cable speeds of the adjacent cables 11.1 and 11.2 such as arise with running surface differences of the drive pulleys, large shearing forces in the transition region of the cable casing 13, which can lead to material failure in the said region. These shearing forces lead to shear stresses which lie in the low double-figure percentage range of the shear strength of the cable casing material.

A suitable material for production of the cable casing 13 is polyurethane. Two commercially available polyurethane synthetic materials suitable for use as the cable casing 13 are Elastollan 1185 and Elastollan 1180, which slightly differ. Elastollan is a registered trade mark of the BASF.

Examples of relative displacements of the cables 11.1, 11.2 are presented in concrete terms in the following.

Elastollan 1185 has a modulus of elasticity of 20 MPa, a shear modulus of 9 MPa and a Poisson's ratio of 0.11. If now the cables 11.1, 11.2 displace relative to one another by a longitudinal displacement s =0.8 millimeters there results in the case of a cable spacing “t” of 2.3 millimeters, a web length “LI” of 3.0 millimeters, a web thickness “d” of 3.4 millimeters and the use of Elastollan 1185, a shearing force of 32.1 N and a shear stress of 3.15 MPa, which the web absorbs. This example shows that the webs absorb only small shearing forces and the shear stress resulting therefrom lies far below the shear strength of the above-mentioned polyurethane. The shear stresses reach approximately 15% of the shear strength.

Shearing forces of 24.3 N and shear stresses of 2.4 MPa result under the same conditions as above for an Elastollan 1180 with a shear modulus of 6.8 MPa. The shear stresses reach approximately 11% of the shear strength.

Further examples for longitudinal displacement “s” of the cables 11.1, 11.2 of 0.7 millimeters and 0.6 millimeters in the case of use of Elastollan 1185 yield shear stresses of 2.7 MPa and 2.4 MPa. These shear stresses respectively correspond with 13% and 11% of the shear strength.

Elastomers have a yield elongation of more than 100% which can amount to up to 800%. However, it is to be noted that elongations of 25% and more are to be avoided, since otherwise irreversible deformations can quite easily occur. The longitudinal displacements “s” of 0.6, 0.7 and 0.8 millimeters of the cables 11.1, 11.2 shown by way of example in the foregoing correspond with strains of 20% and less. It follows therefrom that relative displacements of the cables 11.1, 11.2 in the sub-millimeter range do not lead to impermissible material loads of the webs 14.1, 14.1a, 14.1b, 14.1c.

Moreover, it is possible to equip the individual webs 14.1, 14.1a, 14.1b, 14.1c with a mechanical reinforcement.

The use of the support means 10, 10a, 10b, 10c with synthetic fiber cables is particularly preferred. Metallic, synthetic and/or organic strands 12, or a combination of the said materials, is or are particularly preferred.

The cables 11.1, 11.2 are preferably produced by two-stage or multi-stage twisting of the strands 12. The cables 11.1, 11.2 comprising three layers 12.2, 12.3, 12.4 with strands and a central strand 12.1 are shown in FIG. 1A. However, this is only an example for the construction of the cables 11.1, 11.2.

Cable yarns of aramide fibers, for example, can be twisted together in the cables 11.1, 11.2.

As can be seen in the figures, the entire outer circumference of the cables 11.1, 11.2 is enclosed by the common cable casing 13 of synthetic material. The cable casing 13 can comprise synthetic and/or organic materials. The following materials are particularly suitable as cable casings: rubber, polyurethane, polyolefine, polyvinylchloride or polyamide. The respective resiliently deformable synthetic material is preferably sprayed or extruded on the cables 11.1, 11.2 and subsequently compacted thereon. The cable casing material thereby penetrates from outside into all interstices between the strands 12 at the outer circumference and fills up these. The thus-created coupling of the cable casing 13 to the strands 12 is so strong that only small relative movements arise between the strands 12 of the cables 11.1, 11.2 and the cable casing 13.

According to a further embodiment short fiber pieces (for examples glass fibers, aramide fibers or the like) or a woven mat can be embedded in the web 14 and serves or serve as reinforcement.

The support means 10, 10a, 10b, 10c shown in the figures are particularly suitable for drive by a cable pulley, wherein the force transmission between the cable pulley and the support means takes place substantially by friction couple.

The two or more cables 11.1, 11.2 are, according to the present invention, so connected together that the torsional moment of one cable 11.1 is transmitted to the other cable 11.2 and conversely. The torsional moments thereby compensate one another. In the ideal case the total torsional moment of the support means 10, 10a, 10b, 10c in the case of an even-numbered number of cables and with symmetrical construction is equal to zero. By contrast to the known support means, the cables of the support means according to the present invention are not connected together by a single transition region extending over the entire length of the support means, but by a number of the webs 14.1, 14.1a, 14.1b, 14.1c (plurality of transverse connections). These transverse connections are relatively stiff relative to forces transverse to the longitudinal direction L of the support means, but are designed to be sufficiently narrow with respect to the longitudinal direction of the support means. By comparison with conventional support means according to the state of the art cited above, the transverse connections in the support means according to the present invention are significantly less stiff in the longitudinal direction. The transverse connections of the cables are thereby relatively easily resiliently deformable by shear forces in the longitudinal direction L of the support means 10, 10a, 10b, 10c (by contrast to the state of the art). The two cables 11.1, 11.2 of the support means can accordingly easily be displaced relative to one another in the longitudinal direction L by shear forces acting in the longitudinal direction. Equally, the two cables 11.1, 11.2 can accept stretchings of different magnitude in the longitudinal direction L without damage of the transverse connections.

The forms of embodiment according to the present invention make it possible to avoid fractures or weakenings in the transition region 14 in that shearing movements are converted into longitudinal displacements parallel to the longitudinal axis L. Damage of the transition region 14 and at the same time abrasion of conventional support means with two or more cables can thereby be reduced.

The double, triple or multiple cable according to the present invention can without problems provide compensation for running radius differences at drive pulleys when the cables of the support means move at a drive pulley along circular paths of different radius and accordingly at different speed at the circumference of the drive pulley.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A support means for an elevator installation, comprising;
at least two cables each formed of a plurality of strands for acceptance of force in a longitudinal direction of the support means, said at least two cables being spaced a predetermined distance from one another along the longitudinal direction; and
a cable casing connecting said at least two cables and forming a transition region which lies between said at least two cables, said transition region having a plurality of openings and webs alternating in the longitudinal direction, said webs being resiliently deformable relatively easily by shearing forces in the longitudinal direction to provide a relative displacement of said at least two cables with respect to one another in the longitudinal direction.

2. The support means according to claim 1 wherein said strands of one of said at least two cables and said strands of another of said at least two cables are loaded by intrinsic torsional moments of an opposite sense so as to avoid twisting of the support means along the longitudinal direction.

3. The support means according to claim 1 wherein said cable casing is formed of synthetic and/or organic materials.

4. The support means according to claim 1 wherein said strands are formed of at least one of metallic, synthetic and organic materials.

5. The support means according to claim 1 wherein said openings are formed as slots extending in the longitudinal direction.

6. The support means according to claim 1 wherein said openings and said webs have different lengths in the longitudinal direction.

7. The support means according to claim 1 wherein said webs have, in a plane including said at least two cables, one of a dumbbell, cylindrical, oval, concave, convex, rectangular and wedge shape.

8. The support means according to claim 1 wherein said transition region with said webs is formed as an integral component of said cable casing and firmly connects together said at least two cables.

9. The support means according to claim 1 wherein said webs in response to relative displacement of said at least two cables in the longitudinal direction transmit shear stresses of a maximum of one of 20%, 15% and 10% of a shear strength of an elastomeric material from which said webs are formed.

10. The support means according to claim 1 wherein said webs in response to relative displacement of said at least two cables in the longitudinal direction are stretched by a maximum of one of 25%, 20%, 15%, 10% and 5%.

11. A support means for an elevator installation, comprising;
at least two cables each formed of a plurality of strands for acceptance of force in a longitudinal direction of the support means, said at least two cables being spaced a predetermined distance from one another along the longitudinal direction; and
a cable casing connecting said at least two cables and forming a transition region which lies between said at least two cables, said transition region having a plurality of openings and webs alternating in the longitudinal direction, said openings being greater in length in the longitudinal direction than said webs, said webs being resiliently deformable relatively easily by shearing forces in the longitudinal direction to provide a relative displacement of said at least two cables with respect to one another in the longitudinal direction.
